(19) United States
(12) Patent Application Publication
(10) Pub. No.: US 2024/0307715 A1
(43) Pub. Date: Sep. 19, 2024

(54) Nose Mask

(71) Applicant: DANIA ALTAGRACIA PELLERANO, ALBUQUERQUE, NM (US)

(72) Inventor: DANIA ALTAGRACIA PELLERANO, ALBUQUERQUE, NM (US)

(21) Appl. No.: 18/586,579

(22) Filed: Feb. 26, 2024

Related U.S. Application Data
(63) Continuation of application No. 18/109,727, filed on Feb. 14, 2023, now Pat. No. 11,911,638.
Application No. 18/109,727 is a continuation of application No. 17/074,577, filed on Oct. 19, 2020, now Pat. No. 11,602,649.

(51) Int. Cl. A62B 23/06; A41D 13/11; A62B 18/08

(52) U.S. Cl. CPC A62B 23/06; A41D 13/1107; A62B 18/084

(57) ABSTRACT

The nose mask is intended to be used during Airborne Pandemic. The Nose Mask is a single Triangle/Cone shaped that covers only the nose, that comes with two ear elastic bands or a single head elastic band for support. The Nose Mask is designed to be disposable with filter for better protection and minimize the passage of aerosols, fluids and airborne pathogens agents or to be made with washable material allowing users to re-use it.

### CROSS REFERENCE TO RELATED APPLICATIONS

This application is a continuation of U.S. Non-Provisional patent application Ser. No. 18/109,727, filed Feb. 14 2023 at the United States Patent & Trade Mark Office, which is a continuation of U.S. Non-Provisional patent application Ser. No. 17/074,577, filed Oct. 19 2020, at the United States Patent & Trade Mark Office, now U.S. Pat. No. 11,602,649 issued Mar. 14, 2023, the entire contents of each of which is incorporated herein by reference for continuity of disclosure.

### BACKGROUND OF THE INVENTION

1. The present invention relates generally to a nose mask that is designed to be worn by restaurants customers and dental patients more specifically at the time of a Pandemic.

### 2. Description of the Prior Art

On Airborne Pandemic, face masks are first choice option for public protection, except when eating in public or when having dental treatment.

### SUMMARY

In the case of the problems mentioned above, the present invention will provide a disposable, inexpensive, as well as reusable, Nose Mask to be used for everyone, especially for those eating in public or those receiving dental care for times during an Airborne Pandemic.

### BRIEF DESCRIPTION OF THE DRAWINGS

FIG. 1 illustrates a front view of a nose mask with two ears elastic bands according to a first embodiment;

FIG. 2 illustrates a back view of the first embodiment of the nose mask;

FIG. 3 illustrates a base view of the first embodiment of the nose mask;

FIG. 4 illustrates a top view of the first embodiment of the nose mask;

FIG. 5 illustrates a right side view of the first embodiment of the nose mask, the left side mirroring the right side;

FIG. 6 is a closer front view of the first embodiment of the nose mask;

FIG. 7 is an internal view of the first embodiment of the nose mask;

FIG. 8 is an inside view of the nose mask according to the first embodiment and shows a nasal seal and nose ridge;

FIG. 9 illustrates a patient clearly showing base nose sealed by mask of the first embodiment, on a dental chair with incline position with open mouth, water and air at the time of dental treatment able to breath 100% through nose;

FIG. 10 illustrates a front view of the same patient on dental chair shown in FIG. 9, with the Nose Mask of the first embodiment fitted only over the nose, away from the wearer eyes, with plenty space to breath without the claustrophobic feeling;

FIG. 11 illustrates a right side view of nose mask with ears bands according to the first embodiment, the left side mirroring the right side;

FIG. 12 illustrates a wearer wearing a Nose Mask of the first embodiment able to drink/eat, breathing 100% through nose;

FIGS. 13 and 14 illustrate different views of the nose mask of the first embodiments, with two elastic ears band;

FIG. 15 illustrates a front view of a nose mask with a single head elastic band according to a second embodiment;

FIG. 16 illustrates a back view of the second embodiment of the nose mask;

FIG. 17 illustrates a right side view of the second embodiment of the nose mask, the left side mirroring the right side;

FIG. 18 is a closer front view of the second embodiment of the nose mask;

FIG. 19 is a lateral view of patient wearing Nose Mask with single head band of the second embodiment when receiving dental treatment; and

FIGS. 20 and 21 illustrate different respective back views of the nose mask of the second embodiment with a single elastic head band showing a slight layer of foam to sit at ridge of nose, for comfortability of wearer and to give better seal.

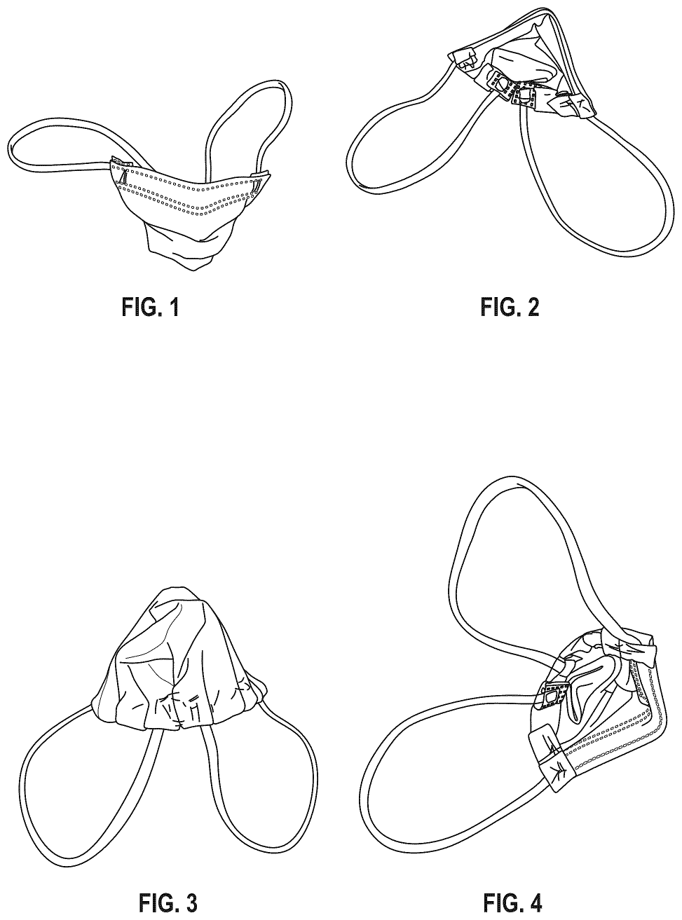

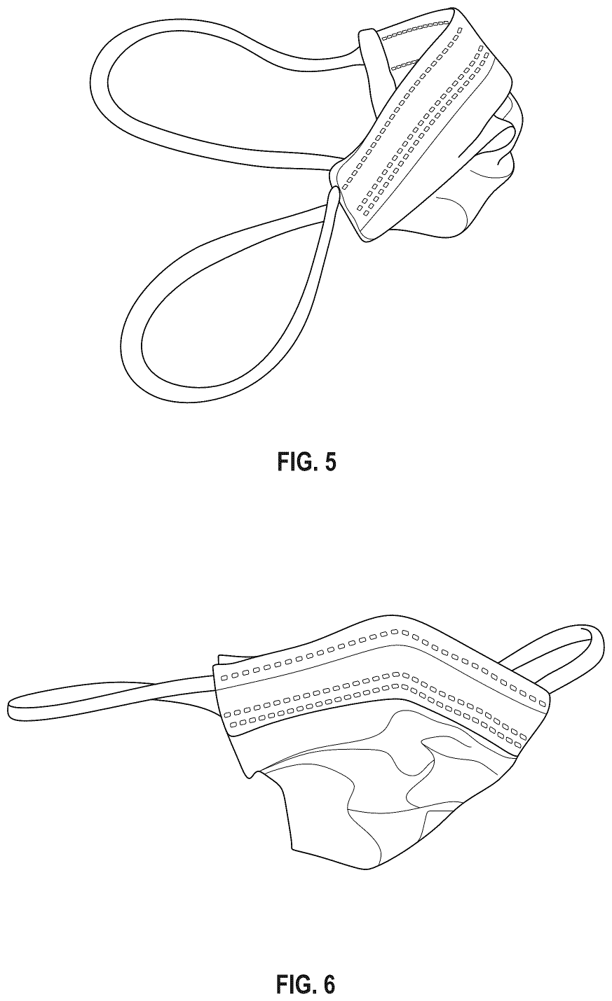

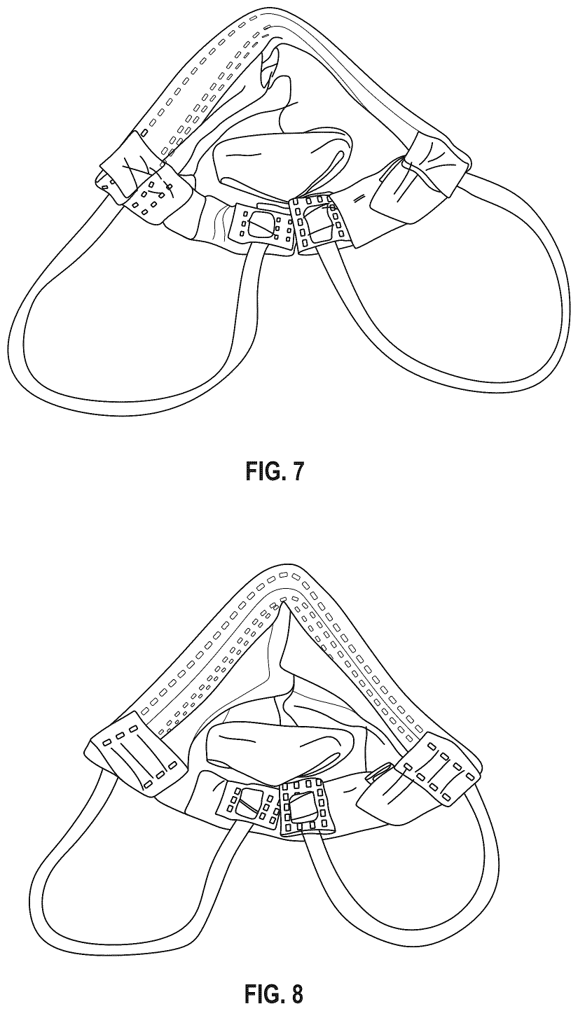

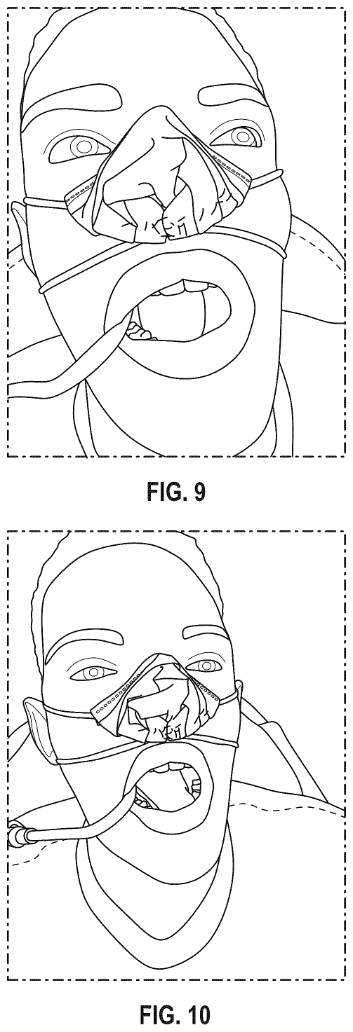

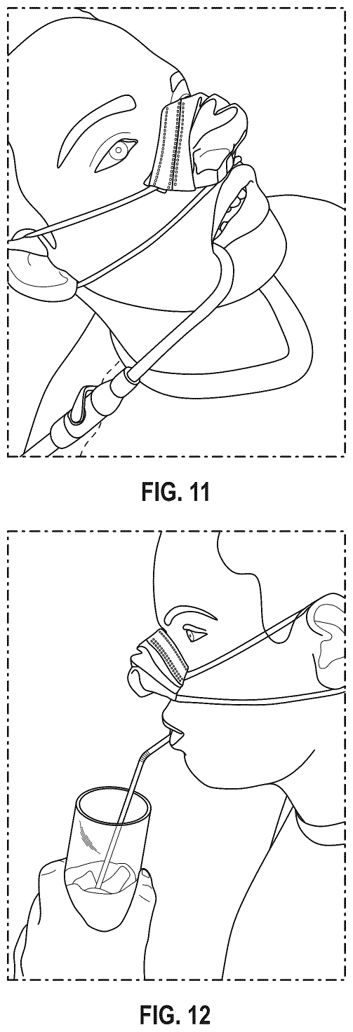

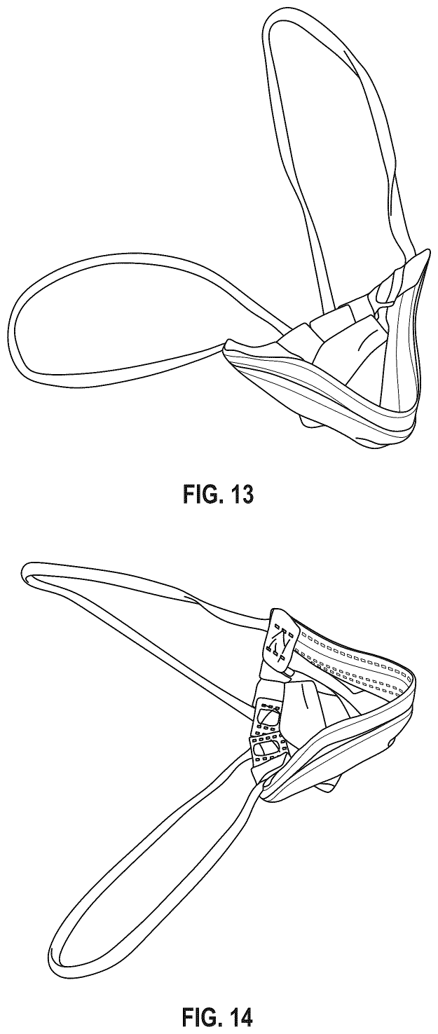

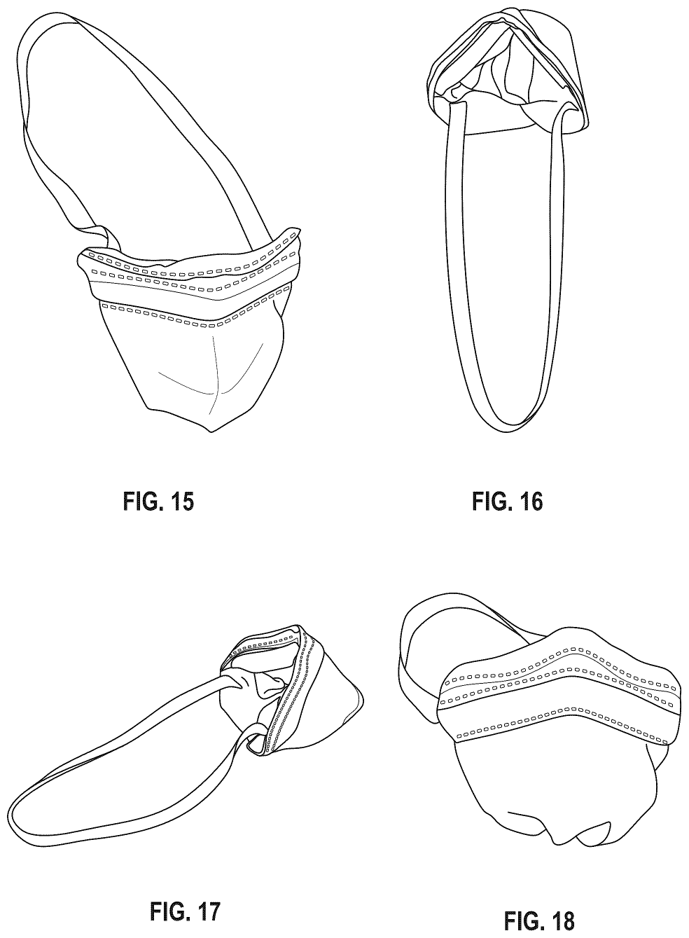

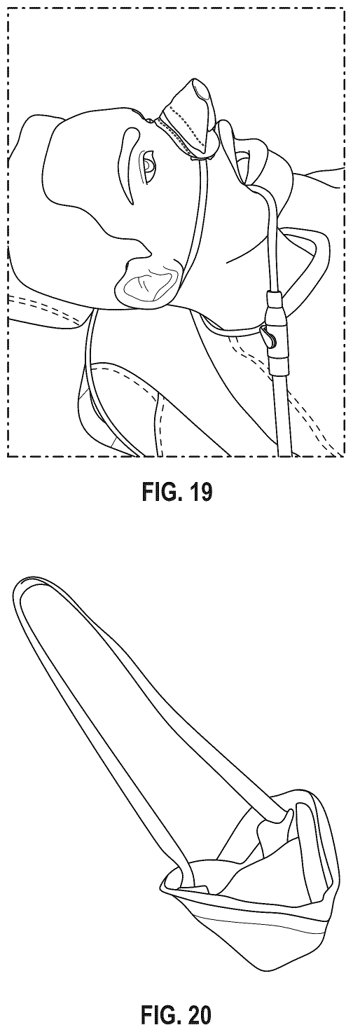

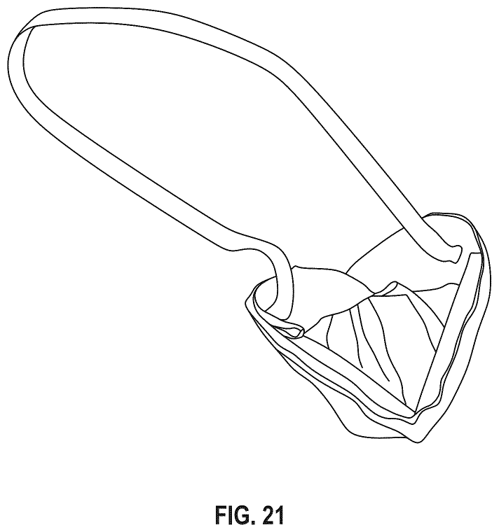

### DETAILED DESCRIPTION

Using the nose mask the wearer will be able to eat and be protected simultaneously, as well as be protected at the time of dental treatment. At eating or receiving dental treatment, the normal anatomical reaction of mouth-air intake is blocked, switching to 100% nose intake. The present invention is a Cone shape designed to be worn over the nose only. The superior angle of the triangle is outlined with a flexible band to sit and be adjusted on the nose's ridge to secure the mask. A slight foam layer inside of the superior angle that sits on the nose ridge for comfort of wearer. The invention is designed to allow wearer to breath comfortably while eating in public and when having dental treatment, decreasing substantially the inhaling of airborne pathogens at the time of large amount of aerosol flow like produced in a dental office. None of the face mask inventions describe this invention as claimed, neither do they expose the mouth to permit anyone to eat or have dental treatment without leaving them unprotected. All masks are designed to be worn over nose and mouth, and a person wearing one of them would need to remove it to be able to eat or to have dental treatment.

1. A disposable Nose Mask comprising: a singular, triangle-like shaped Cone, having a configuration symmetrical on either side forming an appropriately sized cone with enough space to cover only the nose with head or ear bands for support.

2. The disposable Nose Mask of claim 1, further comprising a malleable nose-piece with conforming top edge to a wearer's nose.

3. The disposable Nose mask of claim 1, further comprising two elastic ear bands that go from the upper area of the two bottom angles to the center of the base of the triangle, that pressure and seal the base of nose.

4. The disposable Nose Mask of claim 1, further comprising a single Elastic head-band that goes from an upper area of one side bottom angle to the opposite side angle, making pressure creating a seal at the base of nose.

5. The disposable Nose Mask of claim 1, further comprising layers and filter.

6. The disposable Nose mask of claim 1, wherein the disposable Nose mask is washable.

7. The disposable nose mask of claim 1, further comprising a foam sealing strip attached to the inside top angle surface to sit on wearer ridge of nose.
